(19) United States
(12) Patent Application Publication
(10) Pub. No.: US 2021/0287199 A1
(43) Pub. Date: Sep. 16, 2021

(54) METHOD AND SYSTEM FOR PAYMENT PROCESSING

(71) Applicant: JPMorgan Chase Bank, N.A., New York, NY (US)

(72) Inventors: James A. ROGERS, III, Land O Lakes, FL (US); Zeus J. CORDERO PINO, Tampa, FL (US)

(73) Assignee: JPMorgan Chase Bank, N.A., New York, NY (US)

(21) Appl. No.: 17/183,836

(22) Filed: Feb. 24, 2021

Related U.S. Application Data
(60) Provisional application No. 62/989,201, filed on Mar. 13, 2020.

(51) Int. Cl. G06Q 20/32; G06Q 20/34; G06Q 20/10

(52) U.S. Cl. CPC G06Q 20/327; G06Q 20/102; G06Q 20/348

(57) ABSTRACT

A system and a method for processing a payment by using a card reader device is provided. The method includes: initiating, by a processor, a communication with a server that is associated with a financial institution via an Internet connection; receiving, from the server, a first payment processing application that is associated with the financial institution; receiving, from the card reader device, payment information that relates to a proposed transaction; using the first payment processing application to determine whether to authorize the proposed transaction based on the received payment information; displaying either a confirmation message indicating that the proposed transaction is authorized or a rejection message indicating that the proposed transaction is not authorized; and transmitting a result of the determination to the server.

### CROSS-REFERENCE TO RELATED APPLICATIONS

This application claims the benefit of U.S. Provisional Patent Application Ser. No. 62/989,201, filed Mar. 13, 2020, which is hereby incorporated by reference in its entirety.

### BACKGROUND

### Field of the Disclosure

This technology generally relates to methods and systems for processing payments, and more particularly to methods and systems for using a payment processing application that is downloaded to a web browser that directly interacts with a card reader device to process payments.

### Background Information

Many consumer transactions are executed by using a card reader device that is located at a checkout station within a merchant establishment. Often, when a consumer intends to purchase goods from a merchant by using a charge card, such as a credit card, a debit card, or a gift card, the consumer uses the charge card to enter information into the merchant's card reader device by swiping, inserting or tapping the charge card on the card reader device. The card reader device communicates with a native application on a computer device, such as a desktop personal computer (PC), a laptop PC, a smart phone, or a tablet, which communicates with a web application that is associated with a corresponding financial institution via a gateway connection to the Internet. In this situation, both the web application and the computer device must be connected to the Internet and configured to communicate via the gateway during the execution of the transaction.

Web browsers have recently implemented Bluetooth support and Universal Serial Bus (USB) functionality as trusted communications methods for wireless and wired interactions. As a result, the present inventors have recognized that this functionality may be useful for embedding a financial institution's web application into a merchant application that is hosted on a web browser that directly interacts with the card reader device, in order to provide local control of card reader interactions and to obviate the need for an active communication via an Internet connection during the processing of a transaction.

### SUMMARY

The present disclosure, through one or more of its various aspects, embodiments, and/or specific features or sub-components, provides, inter alia, various systems, servers, devices, methods, media, programs, and platforms for using a payment processing application that is downloaded to a web browser that directly interacts with a card reader device to process payments.

According to an aspect of the present disclosure, a method for processing a payment is provided. The method is implemented by at least one processor. The method includes: initiating, by the at least one processor, a communication with a server that is associated with a financial institution via an Internet connection; receiving, by the at least one processor from the server via the Internet connection, a first payment processing application that is associated with the financial institution; receiving, by the at least one processor from a card reader device, payment information that relates to a proposed transaction; determining, by the at least one processor using the first payment processing application, whether to authorize the proposed transaction based on the received payment information; displaying one from among a confirmation message indicating that the proposed transaction is authorized and a rejection message indicating that the proposed transaction is not authorized; and transmitting, to the server, information that relates to a result of the determining.

Each of the receiving of the payment information, the determining of whether to authorize the proposed transaction, and the displaying of the one from among the confirmation message and the rejection message may be performable while the at least one processor is not actively connected to the Internet.

The method may further include: after the first payment processing application has been received and before the receiving of the payment information, disconnecting the communication with the server and initiating a communication with the card reader device; and after the displaying of the one from among the confirmation message and the rejection message and before the transmitting of the information that relates to the result of the determining to the server, reinitiating the communication with the server.

The card reader device may include a point-of-sale terminal that is associated with a merchant and is configured to obtain the payment data from a card that is associated with a consumer.

The card reader device may be further configured to obtain the payment data from the card as a result of at least one from among the card being physically swiped in a slot of the card reader device, the card being inserted into the slot of the card reader device, and the card being tapped on a surface of the card reader device

The card that is associated with the consumer may include at least one from among a charge card that is associated with the consumer, a credit card that is associated with the consumer, a debit card that is associated with the consumer, and a gift card that is associated with the consumer.

The method may further include embedding, by the at least one processor, the first payment processing application in a second payment processing application that is associated with the merchant.

The receiving of the payment information from the card reader device may be implemented by a wireless communication that is performed in accordance with a Bluetooth standard.

Alternatively, the receiving of the payment information from the card reader device may be implemented by a wired communication that is performed in accordance with a Universal Serial Bus (USB) standard.

According to another exemplary embodiment, a computing apparatus for processing a payment is provided. The computing apparatus includes: a processor; a memory; and a communication interface coupled to each of the processor and the memory. The processor is configured to: initiate, via the communication interface, a communication with a server that is associated with a financial institution via an Internet connection; receive, from the server via the Internet connection and the communication interface, a first payment processing application that is associated with the financial institution; receive, from a card reader device via the communication interface, payment information that relates to a proposed transaction; determine, by using the first payment processing application, whether to authorize the proposed transaction based on the received payment information; display, on a display screen, one from among a confirmation message indicating that the proposed transaction is authorized and a rejection message indicating that the proposed transaction is not authorized; and transmit, to the server via the communication interface and the Internet connection, information that relates to a result of the determining.

The processor may be further configured to: after the first payment processing application has been received and before the receiving of the payment information, disconnect the communication with the server and initiate, via the communication interface, a communication with the card reader device; and after the one from among the confirmation message and the rejection message has been displayed and before the transmission of the information that relates to the result of the determination to the server, reinitiate the communication with the server via the communication interface.

The card reader device may include a point-of-sale terminal that is associated with a merchant and is configured to obtain the payment data from a card that is associated with a consumer.

The card reader device may be further configured to obtain the payment data from the card as a result of at least one from among the card being physically swiped in a slot of the card reader device, the card being inserted into the slot of the card reader device, and the card being tapped on a surface of the card reader device.

The card that is associated with the consumer may include at least one from among a charge card that is associated with the consumer, a credit card that is associated with the consumer, a debit card that is associated with the consumer, and a gift card that is associated with the consumer.

The processor may be further configured to embed the first payment processing application in a second payment processing application that is associated with the merchant.

The processor may be further configured to receive the payment information from the card reader device by implementing a wireless communication that is performed in accordance with a Bluetooth standard.

The processor may be further configured to receive the payment information from the card reader device by implementing a wired communication that is performed in accordance with a Universal Serial Bus (USB) standard.

According to yet another exemplary embodiment, a non-transitory computer readable storage medium storing instructions for processing a payment is provided. The storage medium includes executable code which, when executed by a processor, causes the processor to: initiate a communication with a server that is associated with a financial institution via an Internet connection; receive, from the server via the Internet connection, a first payment processing application that is associated with the financial institution; receive, from a card reader device, payment information that relates to a proposed transaction; determine, by using the first payment processing application, whether to authorize the proposed transaction based on the received payment information; display one from among a confirmation message indicating that the proposed transaction is authorized and a rejection message indicating that the proposed transaction is not authorized; and transmit, to the server, information that relates to a result of the determination.

The executable code may further cause the processor to: after the first payment processing application has been received and before the receiving of the payment information, disconnect the communication with the server and initiate a communication with the card reader device; and after the displaying of the one from among the confirmation message and the rejection message and before the transmission of the information that relates to the result of the determination to the server, reinitiate the communication with the server.

The card reader device may include a point-of-sale terminal that is associated with a merchant and is configured to obtain the payment data from a card that is associated with a consumer.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for using a payment processing application that is downloaded to a web browser that directly interacts with a card reader device to process payments.

FIG. 4 is a flowchart of an exemplary process for implementing a method for using a payment processing application that is downloaded to a web browser that directly interacts with a card reader device to process payments.

FIG. 5 is a data flow diagram that illustrates a series of interactions that are performed during an execution of a method for using a payment processing application that is downloaded to a web browser that directly interacts with a card reader device to process payments, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media haying instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

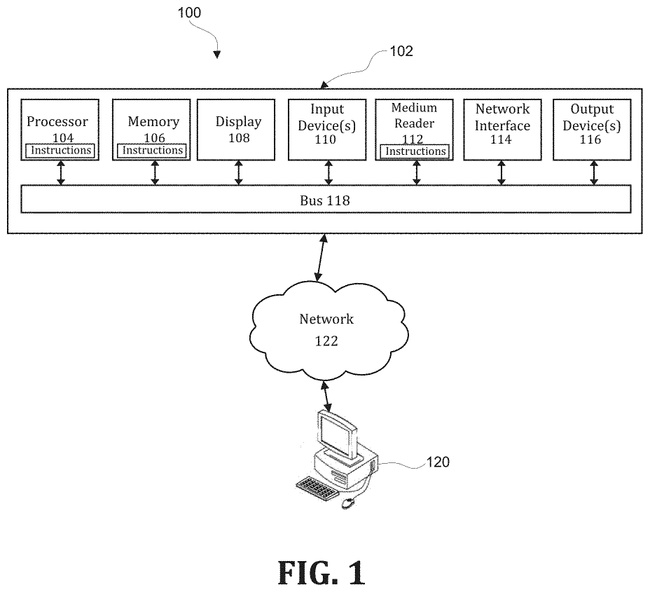

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite ((IPS) device, a web appliance, a device that is running the Apple iOS operating system, a device that is running the Android operating system, a device that is capable of running a web browser to connect to the Internet, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carder wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g, software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, a device that is running the Apple iOS operating system, a device that is running the Android operating system, a device that is capable of running a web browser to connect to the Internet, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for using a payment processing application that is downloaded to a web browser that directly interacts with a card reader device to process payments.

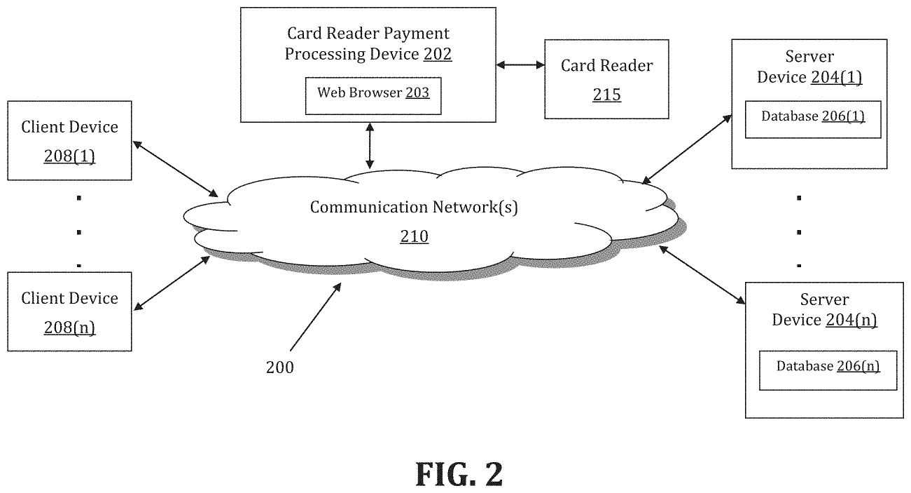

Referring to FIG. 2, a schematic of an exemplary network environment 200 for implementing a method for using a payment processing application that is downloaded to a web browser that directly interacts with a card reader device to process payments is illustrated. In an exemplary embodiment, the method is executable on a web browser 203 that directly interacts with a card reader device 215, such as, for example, a point-of-sale terminal associated with a merchant. Alternatively, the method may be executable on any networked computer platform, such as, for example, a personal computer (PC), a device that is running the Apple iOS operating system, a device that is running the Android operating system, or a device that is capable of running a web browser to connect to the Internet.

The method for using a payment processing application that is downloaded to a web browser that directly interacts with a card reader device to process payments may be implemented by a Card Reader Payment Processing (CRPP) device 202 that is communicatively coupled to a card reader device 215. The CRPP device 202 may be the same or similar to the computer system 102 as described with respect to FIG. 1. The CRPP device 202 may be configured to communicate with the card reader device 215 via either of a wired connection, in accordance with the Universal Serial Bus (USB) standard, or a wireless connection, in accordance with the Bluetooth standard. The CRPP device 202 may store one or more applications that can include executable instructions that, when executed by the CRPP device 202, cause the CRPP device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like. The CRPP device 202 also stores a web browser application 203.

Even further, the application(s) may be operative in a cloud-based computing environment. The application(s) may be executed within or as virtual machine(s) or virtual server(s) that may be managed in a cloud-based computing environment. Also, the application(s), and even the CRPP device 202 itself, may be located in virtual servers(s) running in a cloud-based computing environment rather than being tied to one or more specific physical network computing devices. Also, the application(s) may be running in one or more virtual machines (VMs) executing on the CRPP device 202. Additionally, in one or more embodiments of this technology, virtual machine(s) running on the CRPP device 202 may be managed or supervised by a hypervisor.

In the network environment 200 of FIG. 2, the CRPP device 202 is coupled to a plurality of server devices 204(1)-204(n) that hosts a plurality of databases 206(1)-206(n), and also to a plurality of client devices 208(1)-208(n) via communication network(s) 210. A communication interface of the CRPP device 202, such as the network interface 114 of the computer system 102 of FIG. 1, operatively couples and communicates between the CRPP device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the CRPP device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and CRPP devices that efficiently implement a method for using a payment processing application that is downloaded to a web browser that directly interacts with a card reader device to process payments.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data. Networks (PDNs), combinations thereof, and the like.

The CRPP device 202 may be a standalone device or integrated with one or more other devices or apparatuses, such as one or more of the server devices 204(1)-204(n), for example. In one particular example, the CRPP device 202 may include or be hosted by one of the server devices 204(1)-204(n), and other arrangements are also possible. Moreover, one or more of the devices of the CRPP device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the CRPP device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to consumer accounts associated with a financial institution and merchant-specific transactional data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the CRPP device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the CRPP device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the CRPP device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the CRPP device 202, the server devices 204(1)-204(n), or the client devices 208(1)-208(n), for example, may be configured to operate as virtual instances on the same physical machine. In other words, one or more of the CRPP device 202, the server devices 204(1)-204(n), or the client devices 208(1)-208(n) may operate on the same physical device rather than as separate devices communicating through communication network(s) 210. Additionally there may be more or fewer CRPP devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

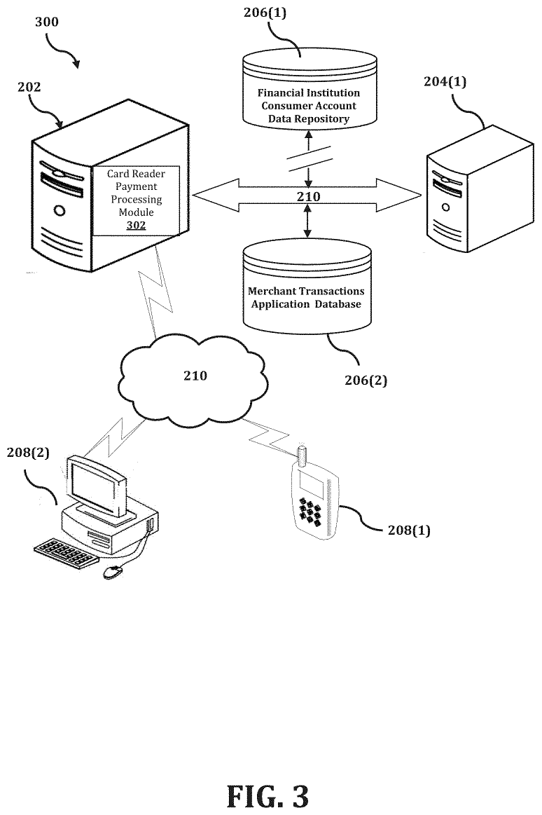

The CRPP device 202 is described and illustrated in FIG. 3 as including a card reader payment processing module 302, although it may include other rules, policies, modules, databases, or applications, for example. As will be described below, the card reader payment processing module 302 is configured to implement a method for using a payment processing application that is downloaded to a web browser that directly interacts with a card reader device to process payments.

An exemplary process 300 for implementing a mechanism for using a payment processing application that is downloaded to a web browser that directly interacts with a card reader device to process payments by utilizing the network environment of FIG. 2 is illustrated as being executed in FIG. 3. Specifically, a first client device 208(1) and a second client device 208(2) are illustrated as being in communication with CRPP device 202. In this regard, the first client device 208(1) and the second client device 208(2) may be “clients” of the CRPP device 202 and are described herein as such. Nevertheless, it is to be known and understood that the first client device 208(1) and/or the second client device 208(2) need not necessarily be “clients” of the CRPP device 202, or any entity described in association therewith herein.

Any additional or alternative relationship may exist between either or both of the first client device 208(1) and the second client device 208(2) and the CRPP device 202, or no relationship may exist. For example, the CRPP device 202 and the first client device 208(1) may be configured as the same physical device, such as, for example, a point-of-sale terminal that is configured to act as a card reader device.

Further, CRPP device 202 is illustrated as being able to access a financial institution consumer account data repository 206(1) and a merchant transactions application database 206(2). The card reader payment processing module 302 may be configured to access these databases for implementing a method for using a payment processing application that is downloaded to a card reader device to process payments.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein,

The process may be executed via the communication network(s) 210, which may comprise plural networks as described above. For example, in an exemplary embodiment, either or both of the first client device 208(1) and the second client device 208(2) may communicate with the CRPP device 202 via broadband or cellular communication. Alternatively, the process may be executed by the CRPP device 202 in a standalone manner, e.g., at a point-of-sale terminal that is associated with a merchant establishment. Of course, these embodiments are merely exemplary and are not limiting or exhaustive.

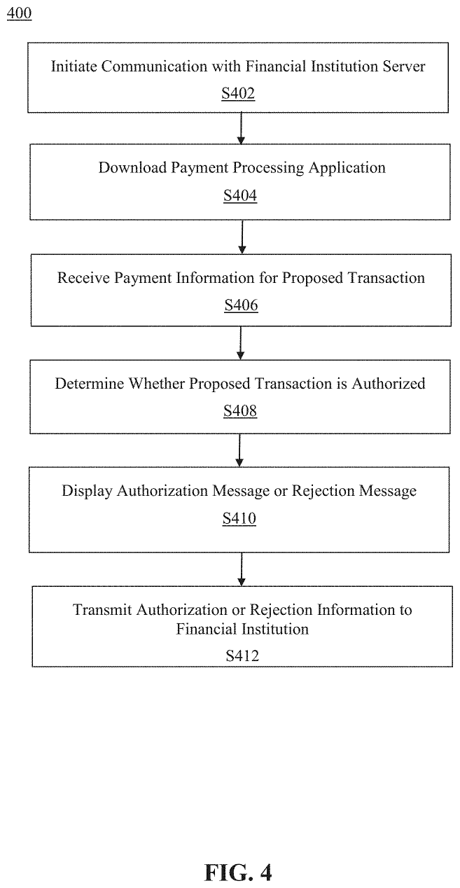

Upon being started, a processor that is hosted in the CRPP device 202 executes a process for using a payment processing application that is downloaded to a web browser that directly interacts with a card reader device to process payments. An exemplary process for using a payment processing application that is downloaded to a web browser that directly interacts with a card reader device to process payments is generally indicated at flowchart 400 in FIG. 4. In exemplary embodiment, the process 400 is implemented in accordance with a Bluetooth standard.

In process 400 of FIG. 4, at step S402, the CRPP device 202 initiates a communication with a server that is associated with a financial institution. In an exemplary embodiment, the communication is performed via an Internet connection.

At step S404, the CRPP device 202 receives a payment processing application that is associated with the financial institution from the financial institution server. In an exemplary embodiment, the payment processing application corresponds to the card reader payment processing module 302, and the CRPP device 202 downloads the module 302 via the Internet connection. In an exemplary embodiment, the received payment processing application may be embedded in a second payment processing application that is associated with a host merchant and that had previously been installed into the CRPP device 202.

At step S406, the CRPP device 202 receives payment information that relates to a proposed transaction. In an exemplary embodiment, the CRPP device 202 is directly connected to a card reader device via a local area network (LAN). In another exemplary embodiment, the CRPP device 202 may be implemented as a point-of-sale terminal that is associated with the merchant, and is configured to obtain the payment information from a card, such as a charge card, a credit card, a debit card, or a gift card, that is associated with a consumer. In this regard, the CRPP device 202 may be configured to enable the consumer to swipe the card in a slot of the device 202, to insert the card in a slot of the device 202, to tap the card on a screen of the device 202, and/or to perform an interaction between the card and the device 202 that causes the payment information to be communicated between the card and the device 202.

At step S408, the CRPP device 202 determines whether to authorize the proposed transaction based on the received payment information. In an exemplary embodiment, the CRPP device 202 uses the embedded card reader payment processing module 302 to make an authorization determination, in a similar manner as could otherwise be performed by using consumer account information that is hosted at a server administered by a financial institution.

At step S410, the CRPP device 202 displays a message that indicates a result of the determination performed in step S408. In an exemplary embodiment, when a determination is made that the proposed transaction is authorized, the CRPP device 202 displays a confirmation message indicating that the transaction is authorized, and when a determination is made that the proposed transaction is not authorized, the CRPP device displays a rejection message indicating that the transaction is denied or that the transaction is not authorized. Then, as step S412, the CRPP device 202 transmits information that indicates the result of the determination to the server associated with the financial institution.

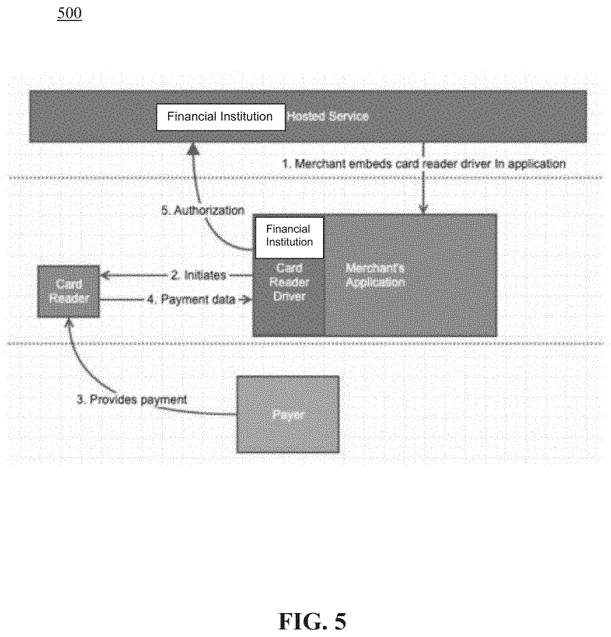

FIG. 5 is a data flow diagram that illustrates a series of interactions that are performed during an execution of a method for using a payment processing application that is downloaded to a card reader device to process payments, according to an exemplary embodiment,

In the exemplary embodiment illustrated in FIG. 5, the client device 208(1) and the CRPP device 202 are configured as the same physical device, such as, for example, a point-of-sale terminal that is configured as a card reader device that includes a processor and a memory.

As illustrated in FIG. 5, in a first interaction, a merchant application embeds a card reader driver into the merchant application. In an exemplary embodiment, the card reader payment processing module 302 is included in a card reader driver, and the embedding interaction is implemented by downloading the card reader driver from a server that is associated with a financial institution.

In a second interaction, the embedded card reader driver initiates a communication with a card reader device, such as, for example, a physical card reader component that is configured to acquire data directly from a charge card.

In a third interaction, a payer provides a payment to the card reader device. For example, when the card reader device is implemented as a point-of-sale terminal and a consumer desires to purchase goods from a merchant, the consumer may be prompted to use a charge card, e.g., a credit card or a debit card, to provide a payment by physically swiping, inserting, or tapping the charge card in a manner that enables the card reader device to obtain consumer account information from the charge card.

In a fourth interaction, the card reader device provides the payment data to the embedded card reader driver. The card reader payment processing module 302 then performs the method 400 in order to determine whether the proposed transaction is authorized. Then, in a fifth interaction, when the result of the method 400 is an authorization, the transaction is completed, and the card reader driver transmits an authorization message to the server associated with the financial institution. Alternatively, when the result of the method 400 is a determination that the proposed transaction is not authorized, the card reader driver may be configured to cause the card reader device to display a message that indicates that the transaction is not authorized.

Accordingly, with this technology, an optimized process for using a payment processing application that is downloaded to a web browser that directly interacts with a card reader device to process payments is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing

What is claimed is:

1. A method for processing a payment, the method being implemented by at least one processor, the method comprising:
initiating, by the at least one processor, a communication with a server that is associated with a financial institution via an Internet connection;
receiving, by the at least one processor from the server via the Internet connection, a first payment processing application that is associated with the financial institution;
receiving, by the at least one processor from a card reader device, payment information that relates to a proposed transaction;
determining, by the at least one processor using the first payment processing application, whether to authorize the proposed transaction based on the received payment information;
displaying one from among a confirmation message indicating that the proposed transaction is authorized and a rejection message indicating that the proposed transaction is not authorized; and
transmitting, to the server, information that relates to a result of the determining.

2. The method of claim 1, wherein each of the receiving of the payment information, the determining of whether to authorize the proposed transaction, and the displaying of the one from among the confirmation message and the rejection message is performable while the at least one processor is not actively connected to the Internet.

3. The method of claim 2, further comprising:
after the first payment processing application has been received and before the receiving of the payment information, disconnecting the communication with the server and initiating a communication with the card reader device; and
after the displaying of the one from among the confirmation message and the rejection message and before the transmitting of the information that relates to the result of the determining to the server, reinitiating the communication with the server.

4. The method of claim 1, wherein the card reader device includes a point-of-sale terminal that is associated with a merchant and is configured to obtain the payment data from a card that is associated with a consumer.

5. The method of claim 4, wherein the card reader device is further configured to obtain the payment data from the card as a result of at least one from among the card being physically swiped in a slot of the card reader device, the card being inserted into the slot of the card reader device, and the card being tapped on a surface of the card reader device.

6. The method of claim 4, wherein the card that is associated with the consumer includes at least one from among a charge card that is associated with the consumer, a credit card that is associated with the consumer, a debit card that is associated with the consumer, and a gift card that is associated with the consumer.

7. The method of claim 4, further comprising embedding, by the at least one processor, the first payment processing application in a second payment processing application that is associated with the merchant.

8. The method of claim 1, wherein the receiving of the payment information from the card reader device is implemented by a wireless communication that is performed in accordance with a Bluetooth standard.

9. The method of claim 1, wherein the receiving of the payment information from the card reader device is implemented by a wired communication that is performed in accordance with a Universal Serial Bus (USB) standard.

10. A computing apparatus for processing a payment, the computing apparatus comprising:
a processor;
a memory; and
a communication interface coupled to each of the processor and the memory,
wherein the processor is configured to:
initiate, via the communication interface, a communication with a server that is associated with a financial institution via an Internet connection;
receive, from the server via the Internet connection and the communication interface, a first payment processing application that is associated with the financial institution;
receive, from a card reader device via the communication interface, payment information that relates to a proposed transaction;
determine, by using the first payment processing application, whether to authorize the proposed transaction based on the received payment information;
display, on a display screen, one from among a confirmation message indicating that the proposed transaction is authorized and a rejection message indicating that the proposed transaction is not authorized; and
transmit, to the server via the communication interface and the Internet connection, information that relates to a result of the determining.

11. The computing apparatus of claim 10, wherein the processor is further configured to:
after the first payment processing application has been received and before the receiving of the payment information, disconnect the communication with the server and initiate, via the communication interface, a communication with the card reader device; and
after the one from among the confirmation message and the rejection message has been displayed and before the transmission of the information that relates to the result of the determination to the server, reinitiate the communication with the server via the communication interface.

12. The computing apparatus of claim 10, wherein the card reader device includes a point-of-sale terminal that is associated with a merchant and is configured to obtain the payment data from a card that is associated with a consumer.

13. The computing apparatus of claim 12, wherein the card reader device is further configured to obtain the payment data from the card as a result of at least one from among the card being physically swiped in a slot of the card reader device, the card being inserted into the slot of the card reader device, and the card being tapped on a surface of the card reader device.

14. The computing apparatus of claim 12, wherein the card that is associated with the consumer includes at least one from among a charge card that is associated with the consumer, a credit card that is associated with the consumer, a debit card that is associated with the consumer, and a gift card that i s associated with the consumer.

15. The computing apparatus of claim 12, wherein the processor is further configured to embed the first payment processing application in a second payment processing application that is associated with the merchant.

16. The computing apparatus of claim 10, wherein the processor is further configured to receive the payment information from the card reader device by implementing a wireless communication that is performed in accordance with a Bluetooth standard.

17. The computing apparatus of claim 10, wherein the processor is further configured to receive the payment information from the card reader device by implementing a wired communication that is performed in accordance with a Universal Serial Bus (USB) standard.

18. A non-transitory computer readable storage medium storing instructions for processing a payment, the storage medium comprising executable code which, when executed by a processor, causes the processor to:
initiate a communication with a server that is associated with a financial institution via an Internet connection;
receive, from the server via the Internet connection, a first payment processing application that is associated with the financial institution;
receive, from a card reader device, payment information that relates to a proposed transaction;
determine, by using the first payment processing application, whether to authorize the proposed transaction based on the received payment information;
display one from among a confirmation message indicating that the proposed transaction is authorized and a rejection message indicating that the proposed transaction is not authorized; and
transmit, to the server, information that relates to a result of the determination.

19. The storage medium of claim 18, wherein the executable code further causes the processor to:
after the first payment processing application has been received and before the receiving of the payment information, disconnect the communication with the server and initiate a communication with the card reader device; and
after the displaying of the one from among the confirmation message and the rejection message and before the transmission of the information that relates to the result of the determination to the server, reinitiate the communication with the server.

20. The storage medium of claim 18, wherein the card reader device includes a point-of-sale terminal that is associated with a merchant and is configured to obtain the payment data from a card that is associated with a consumer.
